(19) United States
(12) Patent Application Publication
(10) Pub. No.: US 2004/0258418 A1
(43) Pub. Date: Dec. 23, 2004

(54) Optical amplifier and optical amplification method

(76) Inventor: Kazuhiro Nojima, Yokohama-shi (JP)

Correspondence Address: LOUIS WOO, LAW OFFICE OF LOUIS WOO, 717 NORTH FAYETTE STREET, ALEXANDRIA, VA, 22314, US

(21) Appl. No.: 10/860,311

(22) Filed: Jun. 4, 2004

(30) Foreign Application Priority Data
Jun. 20, 2003 (JP) 2003-177259

(51) Int. Cl. H04B 10/00

(52) U.S. Cl. 398/160

(57) ABSTRACT

Even when wavelength number of input optical signals is changed, or when the optical signals are intermittently transmitted e.g. in the case of the optical packet signals, amplification with constant output intensities for respective wavelengths is provided. An optical amplifier of the invention comprises a semiconductor laser which outputs light having a constant intensity and a given wavelength λ L, a semiconductor optical amplifier which amplifies part of the input optical signals and output light from the semiconductor laser, an optical filter which extracts only an optic element having a wavelength of λ L among the output light therefrom, a means which provides a rare earth ion-doped optical fiber with other part of the input optical signals and the extracted optic element having a wavelength of λ L. By utilizing nonlinear saturation phenomenon of the semiconductor optical amplifier, when a total optical intensity of the input optical signals having wavelengths from λ s1 to λ sn becomes large, an optical intensity of the optical signal having a wavelength of λ L becomes small. Meanwhile, when a total optical intensity of the optical signals having wavelengths from λ s1 to λ sn becomes small, an optical intensity of the optical signal having a wavelength of λ L becomes large. Therefore, a total intensity of the whole light including light having a wavelength of λ L is always constant, and a gain of the optical amplifier is always constant.

### BACKGROUND OF THE INVENTION

1. Field of the Invention

The present invention relates to an optical amplifier and an optical amplification method, wherein input optical signals are amplified and output through an optical fiber, and more particularly an optical amplifier and an optical amplification method, wherein a rare earth ion-doped optical fiber is used.

2. Description of the Related Art

As a general optical amplifier using a conventional rare earth ion-doped optical fiber, there are examples such as one described in Japanese Unexamined Patent Application Publication No. H08-255944 (FIG. 1, FIG. 4, and ABSTRACT). A simplified construction of this conventional optical amplifier is shown in FIG. 2. This optical amplifier amplifies optical signals having multiple wavelengths from λ s1 to λ sn of n wave. Input multiple wavelength optical signals having wavelengths from λ s1 to λ sn of n wave are input to an rare earth ion-doped optical fiber 102 through an optical isolator 101. In addition, excitation light having a wavelength of λ p is also input to the rare earth ion-doped optical fiber 102 from an excitation light source 104 through a WDM coupler 103. Here, the multiple wavelength optical signals having wavelengths from λ s1 to λ sn which are input to the rare earth ion-doped optical fiber 102 are amplified by the excitation light. The amplified signals having wavelengths from λ s1 to λ sn are output through the WDM coupler 103, part of the signals is branched by an optical splitter 105, and an output level of the optical signals which are output from the optical amplifier is monitored by photoelectric conversion with a photoelectric converter 106. An optical level of the excitation light output from the excitation light source 104 is adjusted by a control circuit 107 so as to obtain a constant output level of the optical signals which are output from the optical amplifier.

In the optical amplifier having the foregoing construction, however, when wave number of the optical signals having wavelengths from λ s1 to λ sn of n wave is increased or decreased, control is made to obtain a constant total optical output intensity. Therefore, respective optical signal levels for respective wavelengths are changed. Further, in the case that optical signals having wavelengths from λ s1 to λ sn are respectively and intermittently transmitted e.g. in the case of the optical packet signals, there is a state of no optical signals for some wavelengths. In this case, optical signal levels for other wavelengths are changed as well.

Further, when the optical packet signals are transmitted, it is impossible to control excitation light immediately corresponding to the optical packet signals. Therefore, amplification of the optical packet signals is not conducted normally. Meanwhile, there is a semiconductor optical amplifier as a means to amplify the optical packet signals. However, when the multiple wavelength optical signals are amplified by the semiconductor optical amplifier, mutual interference is raised between respective optical signals for respective wavelengths due to nonlinearity of the semiconductor optical amplifier, and signal deterioration is caused. In addition, when output from the semiconductor optical amplifier is monitored, and a gain of the semiconductor optical amplifier is changed to obtain its constant output, it becomes impossible to amplify the optical packet signals.

### SUMMARY OF THE INVENTION

In light of the foregoing problems, it is an object of the invention to provide an optical amplifier and an optical amplification method, which provide constant levels of output optical signals for respective wavelengths in amplifying the multiple wavelength optical signals, and which enable stable amplification when the optical signals for respective wavelengths are intermittently transmitted e.g. in the case of the optical packet signals.

In order to attain the foregoing object, the optical amplifier of the invention is constructed to be an optical amplifier, comprising an excitation light source and a rare earth ion-doped optical fiber, which is provided with input optical signals and excitation light produced by the excitation light source, and which outputs amplified optical signals, wherein a semiconductor laser which outputs light having a constant output intensity and a given wavelength, a semiconductor optical amplifier which amplifies part of the input optical signals and output light from the semiconductor laser, an optical filter which extracts only an optic element having the given wavelength of the semiconductor laser among output light from the semiconductor optical amplifier, and a means which provides the rare earth ion-doped optical fiber with other part of the input optical signals and output from the optical filter are provided.

Due to this construction, when the multiple wavelength optical signals are amplified, levels of output respective optical signals having respective wavelengths can be constant. Further, when optical signals for respective wavelengths are intermittently transmitted e.g. in the case of optical packet signals, amplification is enabled in a stable state.

According to the invention, in addition to the foregoing construction, the given wavelength of the semiconductor laser can be set to a value different from wavelength values of the optical signals.

Due to this construction, optical signals for all wavelengths included in the input optical signals can be amplified in a stable state.

According to the invention, in addition to the foregoing constructions, an optical intensity detection means to monitor an output intensity of the optical amplifier, and a control circuit to control a level of the excitation light from the excitation light source so that an optical intensity detected by the optical intensity detection means can be constant can be further provided.

Due to this construction, optical signals for all wavelengths included in the input optical signals can be amplified in a stable state.

According to the invention, in addition to the foregoing constructions, an optical isolator can be provided in the previous stage to the rare earth ion-doped optical fiber, and the excitation light from the excitation light source can be injected from the subsequent stage to the rare earth ion-doped optical fiber.

Due to this construction, optical signals for all wavelengths included in the input optical signals can be amplified in a stable state.

According to the invention, in addition to the foregoing constructions, an erbium-doped optical fiber can be used as the rare earth ion-doped optical fiber.

Due to this construction, the optical amplifier can be constructed by using the optical fiber similar to the optical fiber in the conventional optical amplifier.

According to the invention, in addition to the foregoing constructions, an optical multiplexer can be used as a means to provide the semiconductor optical amplifier with the part of the input optical signals and the output light from the semiconductor laser.

Due to this construction, the optical amplifier can be constructed without a complex structure.

According to the invention, in addition to the foregoing constructions, an optical multiplexer can be used as a means to provide the rare earth ion-doped optical fiber with other part of the input optical signals and the output from the optical filter.

Due to this construction, the optical amplifier can be constructed without a complex structure.

According to the invention, the optical amplification method is an optical amplification method, by which a rare earth ion-doped optical fiber is provided with input optical signals and excitation light, and the optical signals are amplified, wherein a step to produce light having a constant output intensity and a given wavelength, a step to amplify part of the input optical signals and the light having a constant output intensity and a given wavelength, a step to extract only an optic element having the given wavelength among the amplified light, and a step to provide the rare earth ion-doped optical fiber with other part of the input optical signals and the extracted optic element having the given wavelength are provided.

Due to this construction, when the multiple wavelength optical signals are amplified, levels of output respective optical signals having respective wavelengths can be constant. Further, when optical signals for respective wavelengths are intermittently transmitted e.g. in the case of optical packet signals, amplification is enabled in a stable state.

### BRIEF DESCRIPTION OF THE DRAWINGS

FIG. 1 is a block diagram showing a preferred embodiment of an optical amplifier according to the invention; and

FIG. 2 is a block diagram showing a conventional optical amplifier.

### DETAILED DESCRIPTION OF THE PREFERRED EMBODIMENT

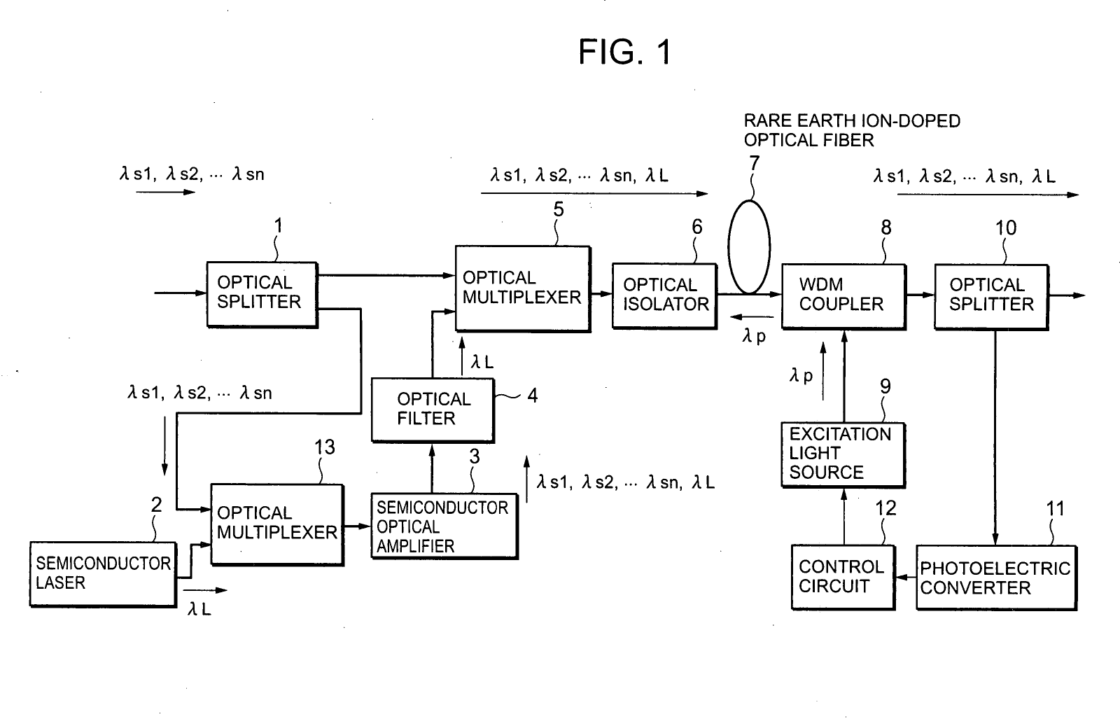

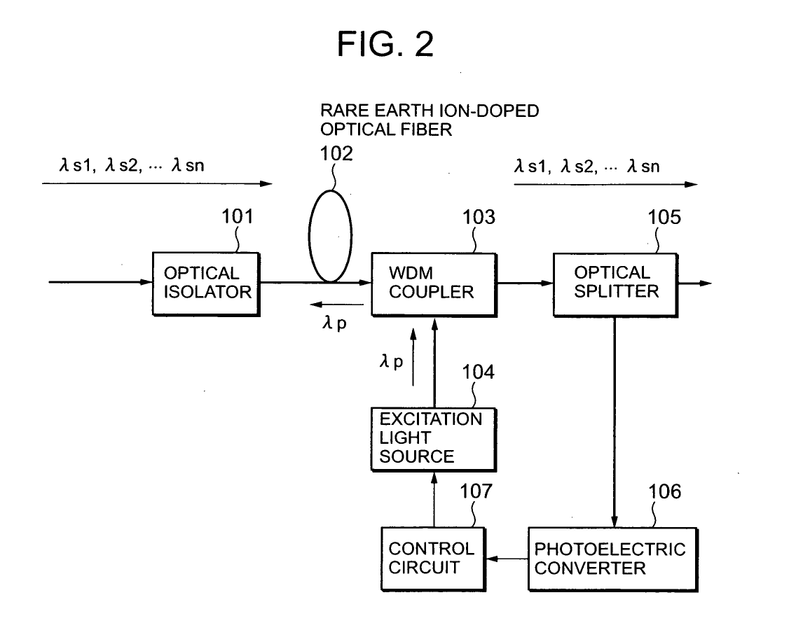

Descriptions will be hereinafter given of an embodiment of the invention with reference to the drawings. FIG. 1 is a block diagram showing the preferred embodiment of an optical amplifier according to the invention. In FIG. 1, a WDM coupler 8, an excitation light source 9, an optical splitter 10, a photoelectric converter 11, and a control circuit 12, which are shown on the right side of a rare earth ion-doped optical fiber 7 have constructions similar to those of corresponding circuits 103 to 107 in FIG. 2. Therefore explanations of their constructions are omitted.

The following components are provided on the left side of the rare earth ion-doped optical fiber 7 in FIG. 1. That is, an optical splitter 1 which branches input optical signals into two, a semiconductor laser 2 which outputs light having a constant output intensity and a given wavelength, an optical multiplexer 13 which inputs and couples each output light from the optical splitter 1 and the semiconductor laser 2, a semiconductor optical amplifier 3 which amplifies output light from the optical multiplexer 13, an optical filter 4 which extracts only an optic element having a given wavelength λ L of the semiconductor laser 2 among output light from the semiconductor optical amplifier 3, an optical multiplexer 5 which couples output light from the optical splitter 1, that is other part of the input light signals and output from the optical filter 4, and an optical isolator 6 as a means to provide the rare earth ion-doped optical fiber 7 with output light from the optical multiplexer 5 are provided.

In the optical amplifier shown in FIG. 1, multiple wavelength optical signals comprised of input optical signals having wavelengths from λ s1 to λ sn of N wave are branched by the optical splitter 1. Optical signals on the one hand branched by the optical splitter 1, and the semiconductor laser 2 outputting an optical signal having a wavelength of λ L and a constant intensity are coupled by the optical multiplexer 13, and the coupled output is input to the semiconductor optical amplifier 3. In the optical filter 4, the optical signal having a wavelength of λ L is extracted from output from the semiconductor optical amplifier 3. In the optical multiplexer 5, other optical signals having wavelengths from λ s1 to λ sn which are branched by the optical multiplexer 1 and the optical signal having a wavelength of λ L output from the optical filter 4 are coupled. The coupled output is input to the rare earth ion-doped optical fiber 7 through the optical isolator 6. In addition, excitation light having a wavelength λ P from the excitation light source 9 is input through the WDM coupler 8 to the rare earth ion-doped optical fiber 7. The rare earth ion-doped optical fiber 7 amplifies in the block the optical signals having wavelengths from λ s1 to λ sn and λ L by the excitation light. The amplified multiple wavelength optical signals having wavelengths from λ s1 to λ sn and λ L pass through the WDM coupler 8 and the optical splitter 10, and then are output as output light of the optical amplifier. Meanwhile, other optical signals branched by the optical splitter 10 are provided with photoelectric conversion by the photoelectric converter 11 in order to monitor the optical intensity. The control circuit 12 controls intensity of the excitation light output from the excitation light source 9 so as to obtain a constant optical output level of the optical amplifier corresponding to the output current or the output voltage from the photoelectric converter 11.

In the foregoing construction, by utilizing nonlinear saturation phenomenon of the semiconductor optical amplifier 3, the optical signal having a wavelength of λ L among the optical signals output from the semiconductor optical amplifier 3 is changed as follows. That is, when a total optical intensity of the optical signals having wavelengths from λ s1 to λ sn becomes large, an optical intensity of the optical signal having a wavelength of λ L becomes small. Meanwhile, when a total optical intensity of the optical signals having wavelengths from λ s1 to λ sn becomes small, an optical intensity of the optical signal having a wavelength of λ L becomes large. Therefore, when a total optical intensity of the optical signals having wavelengths from λ s1 to λ sn which are input to the rare earth ion-doped optical fiber 7 is large, an optical intensity of the optical signal having a wavelength of λ L becomes small. Meanwhile, when a total optical intensity of the optical signals having wavelengths from λ s1 to λ sn which are input to the rare earth ion-doped optical fiber 7 is small, an optical intensity of the optical signal having a wavelength of λ L becomes large.

Therefore, since the optical signals having wavelengths from λ s1 to λ sn and the optical signal having a wavelength of λ L are transmitted to the rare earth ion-doped optical fiber 7 at a ratio with which the total optical intensity of the optical signals having wavelengths from λ s1 to λ sn and the optical signal having a wavelength of λ L is not changed due to change of the optical intensity of the optical signals having wavelengths from λ s1 to λ sn, the total optical intensity of the optical signals having wavelengths from λ s1 to λ sn and the optical signal having a wavelength of λ L is always constant, and optical intensities of respective optical signals for respective wavelengths which are output from the optical amplifier are always constant, even when wave number of wavelengths from λ s1 to λ sn is increased or decreased. Further, also when the optical signals having wavelengths from λ s1 to λ sn are intermittently transmitted, e.g. in the case of the optical packet signals, an optical intensity of the optical signal having a wavelength of λ L is changed as appropriate. Therefore, also in this case, the total optical intensity of the optical signals having wavelengths from λ s1 to λ sn and the optical signal having a wavelength of λ L which are input to the rare earth ion-doped optical fiber 7 is always constant.

As above, when a total optical intensity of the optical signals having wavelengths λ s1 to λ sn and the optical signal having a wavelength of λ L which are input to the rare earth ion-doped optical fiber 7 is always constant, a gain of the optical amplifier is always constant. Further, when input wavelength number is changed, or when the optical signals are intermittently transmitted, e.g. in the case of the optical packet signals, respective optical intensities for respective optical signals for wavelengths from λ s1 to λ sn in the output of the optical amplifier are always constant.

As described above, according to the invention, even when wavelength number of the input optical signals is changed or when input optical signals are intermittently transmitted e.g. in the case of the optical packet signals, respective optical intensities of the optical signals for respective wavelengths can be always constant.

What is claimed is:

1. An optical amplifier, comprising:
an excitation light source and
a rare earth ion-doped optical fiber, which is provided with input optical signals and excitation light produced by the excitation light source, and which outputs amplified optical signals,
wherein a semiconductor laser which outputs light having a constant output intensity and a given wavelength, a semiconductor optical amplifier which amplifies part of the input optical signals and output light from the semiconductor laser, an optical filter which extracts only an optic element having the given wavelength of the semiconductor laser among output light from the semiconductor optical amplifier, and a means which provides the rare earth ion-doped optical fiber with other part of the input optical signals and output from the optical filter are provided.

2. The optical amplifier according to claim 1, wherein the given wavelength of the semiconductor laser is set to a value different from wavelength values of the optical signals.

3. The optical amplifier according to claim 1, wherein an optical intensity detection means to monitor an output intensity of the optical amplifier, and a control circuit to control a level of the excitation light from the excitation light source so that an optical intensity detected by the optical intensity detection means can be constant are further provided.

4. The optical amplifier according to claim 1, wherein an optical isolator is provided in the previous stage to the rare earth ion-doped optical fiber, and the excitation light from the excitation light source is injected from the subsequent stage to the rare earth ion-doped optical fiber.

5. The optical amplifier according to claim 1, wherein the rare earth ion-doped optical fiber is an erbium-doped optical fiber.

6. The optical amplifier according to claim 1, wherein an optical multiplexer is used as a means to provide the semiconductor optical amplifier with the part of the input optical signals and the output light from the semiconductor laser.

7. The optical amplifier according to claim 1, wherein an optical multiplexer is used as a means to provide the rare earth ion-doped optical fiber with other part of the input optical signals and the output from the optical filter.

8. An optical amplification method, by which a rare earth ion-doped optical fiber is provided with input optical signals and excitation light, and the optical signals are amplified,
wherein a step to produce light having a constant output intensity and a given wavelength, a step to amplify part of the input optical signals and the light having a constant output intensity and a given wavelength, a step to extract only an optic element having the given wavelength among the amplified light, and a step to provide the rare earth ion-doped optical fiber with other part of the input optical signals and the extracted optic element having the given wavelength are provided.
